(19) United States
(12) Patent Application Publication
(10) Pub. No.: US 2006/0109472 A1
(43) Pub. Date: May 25, 2006

(54) Apparatus for assay in utilizing attenuated total reflection

(75) Inventor: Katsuaki Muraishi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/229,562

(22) Filed: Sep. 20, 2005

(30) Foreign Application Priority Data
Sep. 21, 2004 (JP) 2004-274119

(51) Int. Cl. G01N 21/55

(52) U.S. Cl. 356/445

(57) ABSTRACT

An assay apparatus of a surface plasmon resonance biosensor system includes a flow channel block loadable with a sensor unit of the chip type removably. A metal film has a sensing surface and a metal/dielectric interface being defined on a dielectric glass substrate. An optical assay unit applies illumination through the glass substrate to the metal/dielectric interface as conditioned for total reflection, detects the illumination reflected by the metal/dielectric interface during the interaction of the ligand and the analyte on the sensing surface. The assay apparatus includes a sensor storage for storing the sensor unit in an unused state. A used sensor receptacle receives the sensor unit in a used state after use in the assay. A transfer assembly retrieves the sensor unit for the assay from the sensor storage, sets the sensor unit on the flow channel block, and discharges the sensor unit toward the used sensor receptacle.

### BACKGROUND OF THE INVENTION

1. Field of the Invention

The present invention relates to an apparatus for assay in utilizing attenuated total reflection. More particularly, the present invention relates to an apparatus for assay in utilizing attenuated total reflection, which is suitable for automation in loading and unloading of a sensor unit of a chip type.

2. Description Related to the Prior Art

An assay apparatus in utilizing attenuated total reflection for assaying a sample is known in the field of the biosensor. A thin film, or metal film, is formed on a transparent dielectric medium. One surface of the metal film is a sensing surface where reaction of a sample occurs. Another surface of the metal film is a metal/dielectric interface where light is applied by satisfying a condition of total reflection. The reaction is detected to assay the sample according to attenuation of the reflected light from the metal/dielectric interface. U.S. Pat. No. 5,313,264 (corresponding to JP-A 4-501462) discloses a surface plasmon resonance (SPR) sensor as a typical example for this assay.

In a metal, free electrons vibrate to generate the compressional wave called a plasma wave. Surface plasmon is a term to mean the compressional wave created on the surface of the metal and included in plasmon as quantized expression of the compressional wave. The surface plasmon travels along the surface of the metal. The surface plasmon resonance (SPR) assay apparatus is constructed to detect surface plasmon resonance created on the sensing surface which is a first surface of the metal film.

Light for detection is applied to a metal/dielectric interface of the metal film that is back to the sensing surface so that the total reflection condition is satisfied, namely at an angle of incidence equal to or more than a critical angle. In addition to the total reflection created on the metal/dielectric interface, a small component of the light passes through the metal film without reflection, and penetrates to the sensing surface. A wave of the penetrating component is called an evanescent wave. Surface plasmon resonance (SPR) is created when frequency of the evanescent wave coincides with that of the surface plasmon. In response to this, intensity of the reflected light attenuates remarkably. In the assay apparatus, the attenuation in the reflected light reflected by the metal/dielectric interface is detected, to recognize creation of the SPR on the sensing surface.

The angle of incidence, namely resonance angle of the light to generate the SPR depends on the refraction index of the transmission medium transmitting evanescent wave and surface plasmon. In other words, a change in the resonance angle to create SPR changes in response to a change in the refraction index of the transmission medium. The substance contacting the sensing surface is a transmission medium transmitting the evanescent wave and surface plasmon. If binding or dissociation between two molecules occurs on the sensing surface, the resonance angle changes because of a change in the refraction index of the transmission medium. In the SPR system, the change in the refraction index is detected, to measure interaction of molecules.

The assay apparatus can be used for various kinds of studies in a biochemical field or the like, antigens and other substances, for example to study interaction of protein, DNA and various biomaterials, and to select candidate drugs by screening. Also, the technique is useful in the fields of the clinical medicine, food industries and the like. It is possible to use one of two substances as a ligand and another of them as an analyte if those have bioaffinity. For the purpose of screening, protein as biomaterial is used as ligand. Candidate drugs are discretely used as analyte, and contacted with the ligand on the sensing surface, to study interaction.

JP-A 6-167443 and U.S. Pat. No. 5,822,073 disclose discloses an SPR assay apparatus in which an optical system of Kretschmann configuration is used for incidence of light to the metal film. According to the Kretschmann configuration, the surface of the metal film as metal/dielectric interface is fitted on a prism, which condenses light and directs the light to the metal/dielectric interface in a manner conditioned for total reflection. A sample or ligand is immobilized on the sensing surface. A flow channel is formed to have the sensing surface inside, and causes analyte fluid to flow. The analyte fluid is introduced in the flow channel to flow, and is caused to contact the ligand. Interaction between the analyte fluid and the ligand is assayed by detecting surface plasmon resonance created during the reaction.

The assay apparatus disclosed in the document includes an apparatus main unit, and an assay stage having a prism and a flow channel. A sensor unit of a chip type is used with the assay stage. The sensor unit includes a glass substrate having a refraction index equal to that of the prism, and metal film overlaid on the glass substrate. The sensor unit with the sensor chip is loadable into the apparatus main unit, of which the assay stage is provided with the sensor unit with the sensor chip by positioning the sensing surface in the flow channel of the flow cell and positioning the metal/dielectric interface on the prism. The sensor unit with the sensor chip has been loaded and unloaded by manual operation of an operator.

However, there is a problem in complexity in manual operation for loading the sensor unit with the sensor chip in the assay stage. Throughput in obtaining data of the assay will be low if the number of the sensor unit with the sensor chip to be assayed increases. No known techniques are successful in automating the handling of the sensor unit with the sensor chip.

### SUMMARY OF THE INVENTION

In view of the foregoing problems, an object of the present invention is to provide an apparatus for assay in utilizing attenuated total reflection, which is suitable for automation in loading and unloading of a sensor unit of a chip type.

In order to achieve the above and other objects and advantages of this invention, an assay apparatus for assay in utilizing attenuated total reflection is provided, including an assay stage for being loaded with at least one sensor unit of a chip type removably, the sensor unit having a transparent dielectric medium of a panel shape, and thin film with a first surface and a sensing surface reverse to the first surface, the first surface being fitted on the dielectric medium and constituted by a thin film/dielectric interface, and the sensing surface being adapted to causing interaction between ligand and analyte, and including a flow channel block, disposed in the assay stage, and having a flow channel for flowing of the analyte to the sensing surface, and an optical assay unit for applying illuminating light through the dielectric medium to the thin film/dielectric interface in such a form as to satisfy a condition of total reflection, and for detecting the illuminating light reflected by the thin film/dielectric interface during the interaction of the ligand and the analyte. The assay apparatus includes a sensor storage for storing the sensor unit of the chip type in an unused state. A used sensor receptacle receives the sensor unit in a used state after advance to the assay stage and use in the assay. A transfer assembly retrieves the sensor unit for the assay from the sensor storage, sets the sensor unit in the assay stage, and discharges the sensor unit toward the used sensor receptacle.

Preferably, the optical assay unit includes a prism for firmly contacting the dielectric medium in the sensor unit, and for passing the illuminating light to the thin film/dielectric interface. Furthermore, a shiftable mechanism keeps the flow channel block and the prism movable between a pressure position and a free position, wherein the flow channel block and the prism, when in the pressure position, squeeze the sensor unit between, and when in the free position, have looseness relative to the sensor unit and set free the sensor unit.

Preferably, the transfer assembly includes a pickup mechanism for picking up the sensor unit from the sensor storage. A transfer shifter shifts the sensor unit being picked up to a standby position. A sensor transport mechanism shifts the sensor unit from the standby position to the assay stage.

Preferably, the transfer assembly further includes a controller for, after the assay in the assay stage, causing the sensor shifter mechanism for shifting the sensor unit from the assay stage to the standby position, for causing the transfer shifter to shift the sensor unit from the standby position to an upside of the used sensor receptacle, and for causing the pickup mechanism to discharge the sensor unit to the used sensor receptacle.

Preferably, the pickup mechanism includes a pickup pad for capturing the sensor unit in the sensor storage. A substantially vertical shifter supports the pickup pad to move the pickup pad in a substantially vertical direction.

Preferably, the pickup pad is constituted by a suction device for retaining the sensor unit by suction.

Preferably, the transfer shifter includes a transfer belt, and a carriage, secured to the transfer belt, for moving when the transfer belt turns about. The pickup mechanism is secured to the carriage.

Preferably, the standby position is defined between the sensor storage and the assay stage. The transfer belt turns about in a forward direction before the assay, and turns about in a backward direction after the assay, for returning the sensor unit from the standby position.

Preferably, the used sensor receptacle is disposed between the sensor storage and the standby position. The transfer belt turns about in a forward direction before the assay, for moving the sensor unit from the used sensor receptacle to the standby position, and turns about in a backward direction after the assay, for moving the sensor unit from the standby position towards the used sensor receptacle.

Preferably, the sensor transport mechanism includes plural transport rolls rotatable back and forth, engaged with the sensor unit, for moving the sensor unit between the standby position and the assay stage.

In one preferred embodiment, there is a sensor rack, having a plurality of tray portions, laid over one another therein, for constituting the sensor storage and the used sensor receptacle, and for respectively containing the sensor unit.

Preferably, the transfer assembly includes a transfer shifter for moving the sensor unit toward and away from the tray portions. A substantially vertical shifter moves one of the sensor rack and the transfer shifter substantially in a vertical direction relative to a remaining one thereof, to set one of the tray portions at the transfer shifter where the sensor unit to be moved toward or away from the sensor rack is disposed.

Preferably, the sensor rack includes a rack casing, having a prismatic tubular shape, and disposed to extend substantially in the vertical direction. At least one lateral opening is formed in a lateral face of the rack casing, for allowing the transfer shifter to access the tray portions, to keep the sensor holder movable in and out.

Preferably, the vertical shifter moves the sensor rack.

### BRIEF DESCRIPTION OF THE DRAWINGS

The above objects and advantages of the present invention will become more apparent from the following detailed description when read in connection with the accompanying drawings, in which:

FIG. 1A is a cross section, partially broken, illustrating a sensor unit in an assay apparatus according to the SPR sensing and in a sample immobilizing process;

FIG. 1B is an explanatory view in cross section, illustrating the assay apparatus in an assay process and data analyzing process;

FIG. 2 is an exploded perspective illustrating the sensor unit;

FIG. 3 is an explanatory view in side elevation, illustrating the assay apparatus;

FIG. 4 is an explanatory view in side elevation, illustrating another preferred embodiment in which a sensor rack is used.

### DETAILED DESCRIPTION OF THE PREFERRED

### EMBODIMENT(S) OF THE PRESENT INVENTION

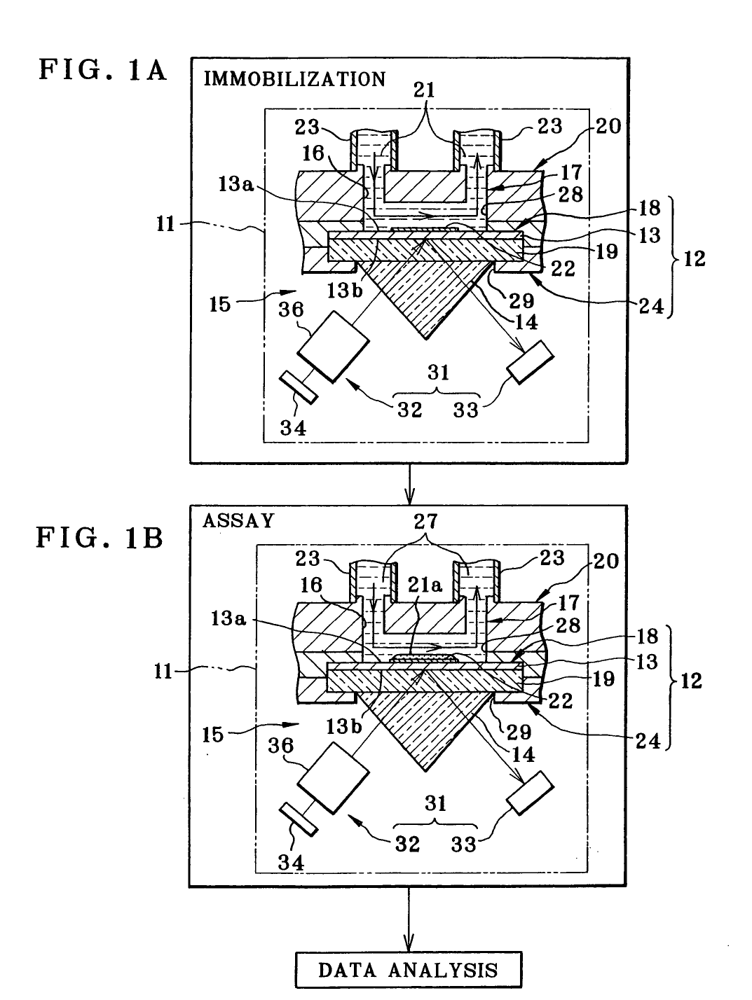

In FIGS. 1A and 1B, a system for measuring or assay according to SPR (surface plasmon resonance) is illustrated. A sequence of the assay system is constituted by three processes which are a sample immobilizing process, assay process and data analyzing process. The assay system includes a sample immobilizing device, an assay apparatus 11, and a data analyzer.

An SPR (surface plasmon resonance) sensor cartridge or sensor unit 12 is a chip type and used for assay. An assay stage 15 of the assay apparatus 11 is loaded with the sensor unit 12. The sensor unit 12 includes a cartridge casing 24 and a sensor chip 18. The sensor chip 18 includes a glass substrate 19 and metal film 13. The glass substrate 19 is dielectric and has a thin plate shape. The metal film 13 is a coating overlaid on the glass substrate 19. A sensing surface 13a is a first surface of the metal film 13 directed upwards, to create surface plasmon resonance (SPR). A metal/dielectric interface or light entrance surface 13b is a second surface of the metal film 13 directed downwards in contact with the glass substrate 19. An example of material for the metal film 13 is gold (Au). A thickness of the metal film 13 is 50 nm. The thickness can be changed for the suitability in view of the material of the metal film 13, a wavelength of light to be applied, and the like. The metal film 13 is deposited on the glass substrate 19 by vapor deposition.

A flow channel block 20 is disposed in the assay stage 15. A flow channel 16 is formed in the flow channel block 20, and associated with the sensing surface 13a. A prism 14 is located in the assay stage 15, so disposed as to define the metal/dielectric interface 13b in combination with the metal film 13. The sensor unit 12 is fitted between the flow channel block 20 and the prism 14 vertically in the assay stage 15.

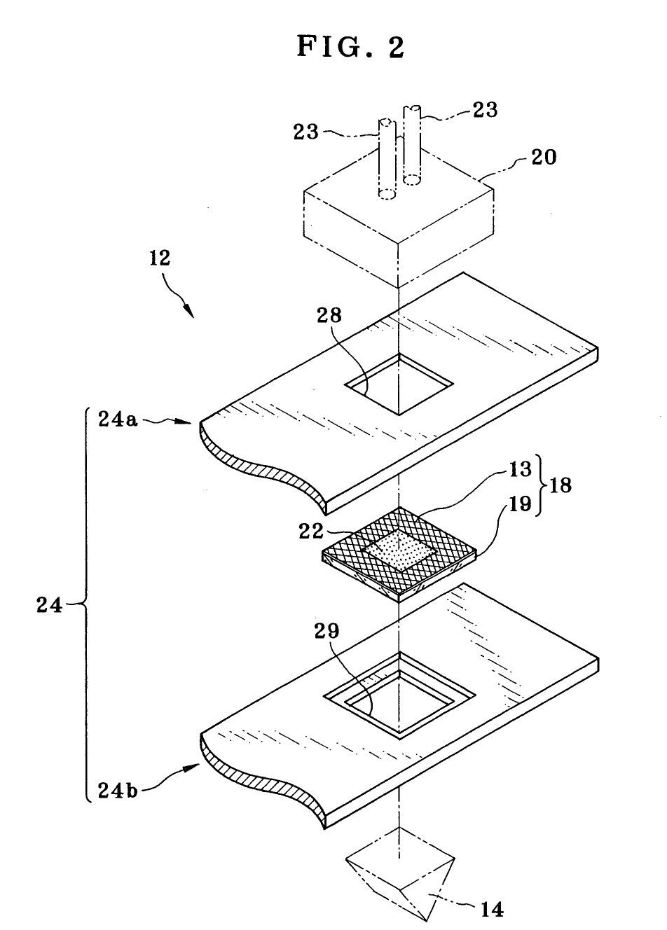

In FIG. 2, the cartridge casing 24 includes an upper panel 24a and a lower panel 24b. An upper opening 28 is formed in the upper panel 24a, and causes the sensing surface 13a to appear. A lower opening 29 is formed in the lower panel 24b, and causes the metal/dielectric interface 13b to appear. The sensor chip 18 is maintained between the panels 24a and 24b. An upper surface of the lower panel 24b has a recess portion on the periphery of the lower opening 29, into which a lower half of the sensor chip 18 is fitted. Also, a lower surface of the upper panel 24a has a recess portion (not shown) on the periphery of the upper opening 28, into which an upper half of the sensor chip 18 is fitted. Thus, the position of the sensor chip 18 is determined correctly. The sensor chip 18 is handled in a state contained in the cartridge casing 24.

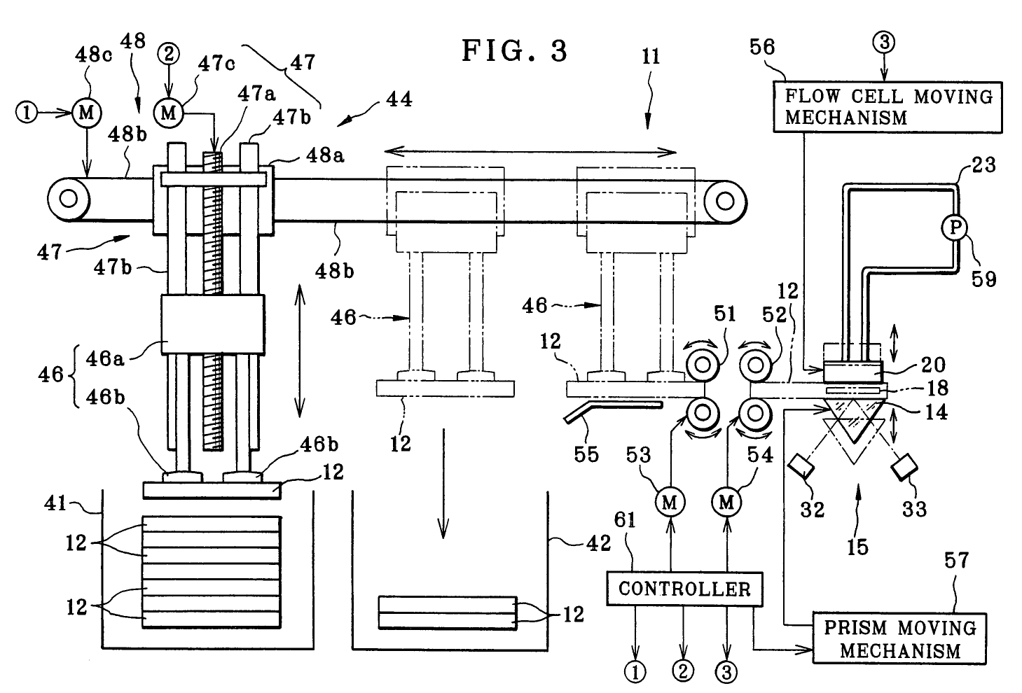

A lower surface of the flow channel block 20 is fitted firmly on an upper surface of the upper panel 24a by positioning the flow channel 16 at the upper opening 28. A lower side of the flow channel 16 is open. When the flow channel block 20 contacts the sensor unit 12, the open lower side is closed and tightly enclosed by the inside of the sensing surface 13a and the inner face of the upper opening 28. Thus, a sensor cell or flow cell 17 is constituted by the flow channel 16, the upper opening 28 and the sensing surface 13a, to enable flow of a liquid to the sensing surface 13a through the flow channel 16. A conduit 23 is connected with each of ends of the flow channel 16 in the flow channel block 20, and is adapted to flow of liquids including ligand and analyte for introduction and removal. A pump 59 is connected with the conduit 23 for applying pressure and negative pressure to the inside of the conduit 23 for introduction and removal of liquids. See FIG. 3.

An upper face of the prism 14 is inserted in the lower opening 29 formed in the lower panel 24b, and connected with a lower surface of the glass substrate 19 in a tightly fitted manner. The upper face of the prism 14 is coated with matching liquid such as gel or oil for the purpose of matching the refraction index with the glass substrate 19. When the sensor unit 12 is set in the assay stage 15, the matching liquid is sandwiched between the prism 14 and the glass substrate 19. Under the prism 14 is disposed an optical assay unit 31, which includes an illuminator 32 and a photo detector 33. The prism 14 condenses light emitted by the illuminator 32 toward the metal/dielectric interface 13b. Note that the illuminator 32 operates for the emission to satisfy the condition of the total reflection on the metal/dielectric interface 13b. The light condensed by the prism 14 passes through the glass substrate 19 toward the metal/dielectric interface 13b. The prism 14 is shaped in a triangular prismatic form. See FIG. 2. Various forms may be used to shape the prism 14 in satisfying the condition of the total reflection on the metal/dielectric interface 13b, for example, a semispherical form, a semi-cylindrical form having a semicircular shape in section, a pyramidal form and the like.

The illuminator 32 in the optical assay unit 31 is referred to now. The interaction between the ligand and analyte can be recognized as a change of a resonance angle, which is an angle of incidence of light received by the metal/dielectric interface 13b. To this end, the illuminator 32 is caused to apply light to the metal/dielectric interface 13b at various values of angles of incidence satisfying a condition of the total reflection. The illuminator 32 includes a light source device 34 and an optical system 36, which includes a condensing lens, a diffusing plate and a polarizer. A position and angle of the installation of those elements are so determined that an angle of incidence of the light satisfies the condition of the above total reflection.

Examples of the light source device 34 include a light emitting diode (LED), laser diode (LD), super luminescent diode (SLD), and other light emitting element. The diffusing plate diffuses light from the light source device 34, and suppresses onset of irregularity in the light amount. The polarizer allows only p-polarized light to pass, the p-polarized light creating the surface plasmon resonance. Note that no polarizer is required if directions of rays emitted by the light source device 34, for example an LD, are kept equal. However, a diffusing plate may be combined with the light source device 34 of a type of which directions of emitted rays are kept equal. Directions of rays in polarization are changed unequal by the passage through the diffusing plate. For this structure, the polarizer can be utilized to set equal the directions of the rays. The light obtained after the diffusion and polarization is condensed by a condensing lens, and directed to the prism 14. It is possible to travel rays with various angles of incidence toward the metal/dielectric interface 13b without irregularity in the intensity.

The photo detector 33 receives light reflected by the metal/dielectric interface or light entrance surface 13b, and detects intensity of the light. Rays of light are incident upon the metal/dielectric interface 13b at various angles. It follows that light is reflected by the metal/dielectric interface 13b at various angles of reflection according to the angles of the incidence. If there is a change in the resonance angle according to interaction of the analyte and ligand, a reflection angle at which light is attenuated is changed, too. An example of the photo detector 33 is a CCD area sensor, which retrieves such a change in the reflection angle as a gradual change in the attenuating position of the reflected light by the a photo receptor surface. The photo detector 33 generates measured data which is information of the interaction, and sends the measured data to a data analyzer. The data analyzer, in the data analyzing process, analyzes the measured data from the assay apparatus 11, to retrieve a characteristic and other information of the analyte.

Prior to the assay process, the ligand is immobilized on the sensing surface 13a in the sample immobilizing process. Ligand fluid 21 is caused by the pump 59 to flow through the conduit 23, and introduced to the flow channel 16. The ligand fluid 21 is prepared by ligand and fluid medium to which the ligand is added or mixed. A linker film 22 is formed on the middle of the sensing surface 13a, and can bind with the ligand. Initially, the linker film 22 is formed on the sensor unit 12 in the course of manufacturing the sensor unit 12. As the linker film 22 is a basis for immobilizing the ligand, a type of the linker film 22 is suitably selected from various ligands.

Pre-treatment before immobilization with the ligand fluid 21 is wetting of the linker film 22 by use of liquid buffer, and activation of the linker film 22 for the purpose of facilitating binding of the ligand to the linker film 22. An example of method for the binding is the amine coupling method. An example of material for the linker film 22 is carboxy methyl dextran, to bind an amino group contained in the ligand with the dextran directly by a covalent bond. An example of liquid for the activation is mixture of N′-(3-dimethylaminopropyl)carbodiimide hydrochloride (EDC) and N-hydroxy imide succinate (NHS). After the activation, liquid buffer for immobilization is introduced to wash and clean the flow channel 16.

Various liquids are available for use as the liquid buffer for immobilization, and solvent or diluent for the ligand fluid 21. Examples of the liquids include buffer liquids, or physiological saline water and other aqueous solutions of physiological salts, and pure water. It is possible according to a type of the ligand to determine suitably solution types and pH values of the solutions, and types of substances to be mixed, and their density. If a biomaterial is used as a ligand, physiological saline water is used of which pH value is kept neutralized. In the amine coupling method described above, the linker film 22 is electrified negatively because of the carboxy methyl dextran. In consideration of this, it is possible to use phosphate buffered saline (PBS) solution having strong operation of buffer and containing phosphate salt at high density which is not physiological, because protein can be electrified positively for the purpose of facilitating binding with the linker film 22.

After the activation and washing, the ligand fluid 21 is introduced to the flow cell 17 for a ligand immobilizing process. Ligand or sample 21a such as an antibody diffused in the ligand fluid 21, in introducing the ligand fluid 21, gradually comes near to the linker film 22 and binds with the linker film 22. This is immobilization of the ligand 21a on the sensing surface 13a. It is general that a step of the immobilization requires approximately one (1) hour, during which the sensor unit 12 is preserved in an environment conditioned suitably, for example at a conditioned temperature. In the course of the immobilization, the ligand fluid 21 is caused by the pump 59 to flow into the flow cell 17 continuously for a prescribed period of time. Note that other liquids including the analyte and liquid buffer are caused to flow continuously for a time prescribed for the respective types of liquids.

The flow of the liquid may not be continuous. After the ligand fluid 21 of a regular amount is introduced in the flow cell 17, the flow cell 17 can be left to stand for immobilization in a stationary manner. However, it is preferable to stir or to turbulently flow the ligand fluid 21 in the flow cell 17 for fluidity for the purpose of promoting binding of the ligand on the linker film 22. It is possible to increase an immobilized amount of the ligand by quickening the binding.

When the immobilization of the ligand 21a on the sensing surface 13a is completed, then the ligand fluid 21 is removed from the flow channel 16. The pump 59 discharges the ligand fluid 21 by application of negative pressure. After this, the sensing surface 13a is washed by feeding washing liquid into the flow channel 16. A blocking step, if required, is added after the washing. A blocking liquid is introduced into the flow channel 16, to render inactive the reaction group remaining without binding with the ligand. A preferable example of the blocking liquid is ethanol amine hydrochloride. After the blocking, the flow channel 16 is washed again.

After the ligand is immobilized, the assay is made. At first, liquid buffer for assay is introduced into the flow channel 16, and caused to flow continuously for a prescribed time. After this, analyte solution or analyte fluid 27 as a fluid which contains analyte and fluid medium, is introduced into the flow channel 16. Again, the liquid buffer is introduced after the analyte fluid 27. Note that the flow channel 16 may be cleaned or washed before initially introducing the liquid buffer. Reading of data starts upon initially introducing the liquid buffer in order to detect a reference level of a signal. The reading is continued until the introduction of the liquid buffer at the second time after entry of the analyte fluid 27. It is possible not only to detect the reference level but to assay reaction or binding between the analyte and the ligand, and to measure a signal until dissociation between the analyte and ligand in response to introduction of the liquid buffer.

There are a reaction region (act) and a reference region (ref) formed in the linker film 22. The reaction region has immobilization of a ligand, and is a region for reaction between the ligand and analyte. The reference region does not have immobilization of a ligand, and is used for outputting a reference signal for comparison with a signal retrieved from the reaction region. Note that the reference region is formed in the course of film production of the linker film 22. An example of a process of the forming has steps of surface processing of the linker film 22 at first, and then rendering the reaction groups inactive in approximately a half of an entire area of the linker film 22 for binding with ligand. Thus, a half of the linker film 22 becomes the reaction region. A remaining half of the linker film 22 becomes the reference region.

An act-signal and ref-signal generated from those regions are measured simultaneously in the course of a period starting upon detection of a reference level, and then reaction of binding, and ending upon releasing. Data analysis is effected by obtaining a difference or ratio of the act-signal and ref-signal. For example, a data analyzer obtains data of a finite difference between the act-signal and ref-signal, and analyzes various items according to the finite difference. This makes it possible to cancel electric noise caused by external irregularities, such as individual specificity of sensor units or flow cells, mechanical changes of the assay apparatus, temperature changes of the liquid, and the like. A signal with a high S/N ratio can be obtained.

Note that in the present embodiment, both of the act-region and the ref-region are disposed in each one flow channel. However, it is possible to dispose two flow channels for one flow cell on the same metal film. An act-region may be disposed on a first flow channel and can have the ligand immobilized on the sensing surface. A ref-region may be disposed on a second flow channel and may have no ligand immobilized on the sensing surface. Those flow channels are interconnected at ends, so a U-shape is defined as a combination. It is possible to cause the same liquid to flow in those flow channels.

Various liquids are available for use as the liquid buffer for assay, and solvent or diluent for the analyte fluid 27. Examples of the liquids include buffer liquids, or physiological saline water and other aqueous solutions of physiological salts, and pure water. It is possible according to a type of a ligand to determine suitably solution types and pH values of the solutions, and types of substances to be mixed, and their density. To facilitate dissolving of the analyte, dimethyl sulfo-oxide (DMSO) can be added to the physiological saline water. The use of the DMSO is reflected to a level of an output signal. The buffer for assay is used for detecting the reference level of the signal, as described above. If DMSO is contained in the solvent for the analyte, it is preferable to use buffer for assay at a DMSO density approximately equal to that of the solvent in the analyte.

In general, the analyte fluid 27 may be kept preserved for a long time, for example one year. It is likely that a difference occurs between an initial level and a current level of the DMSO density owing to a change with time. If assay with high precision is required, such a difference in the density is estimated according to the ref-signal level upon introducing the analyte fluid 27, so that measured data can be compensated for by DMSO density compensation. Compensation data for the DMSO density compensation is obtained before introducing the analyte fluid 27. A plurality of liquid buffers different in the DMSO density are introduced to the flow cells 17. Amounts of changes in the levels of ref-signal and act-signal are evaluated so as to obtain the compensation data.

In FIG. 3, the assay apparatus 11 includes a sensor storage 41 and a used sensor receptacle 42 with a discarding chute. The sensor storage 41 stores a plurality of the sensor units 12 before the use for the immobilization and assay. The used sensor receptacle 42 contains numerous used ones of the sensor units 12. The sensor units 12 are stacked in a vertical direction in each of the sensor storage 41 and the used sensor receptacle 42. For the purpose of assay, an unused one of the sensor units 12 is picked up from the sensor storage 41, and transported to the assay stage 15. After the assay, the sensor unit 12 is sent from the assay stage 15 to the used sensor receptacle 42. There is a handling assembly or transfer assembly 44 for transfer of the sensor unit 12 from the sensor storage 41 to the assay stage 15, and back from the assay stage 15 to the used sensor receptacle 42.

The transfer assembly 44 includes a suction device 46, a vertical shifter 47 as pickup mechanism, and a horizontal transfer shifter 48. The suction device 46 retains the sensor unit 12 by suction of its upper surface. The vertical shifter 47 moves the suction device 46 up and down vertically. The horizontal transfer shifter 48 moves the suction device 46 horizontally forwards or backwards together with the vertical shifter 47. The suction device 46 includes a suction tube 46a of a case shape, and suction nozzles 46b as pickup pads formed in a suction surface of the suction tube 46a. The sensor unit 12 is picked up by the suction nozzles 46b from the sensor storage 41.

The vertical shifter 47 includes a ball screw 47a, guide rails 47b and a shifter motor 47c. The guide rails 47b are disposed to extend beside the ball screw 47a. The suction tube 46a of the suction device 46 is secured to the ball screw 47a, and moves up or down when the ball screw 47a rotates. The guide rails 47b guide a direction of moving the suction tube 46a.

The horizontal transfer shifter 48 includes a transfer belt 48b, a carriage 48a and a belt motor 48c. The carriage 48a is secured to the transfer belt 48b. The belt motor 48c causes the transfer belt 48b to turn about. Upper ends of the ball screw 47a an the guide rails 47b are secured to the carriage 48a. When the transfer belt 48b turns about, the carriage 48a is moved to move the vertical shifter 47 and the suction device 46 horizontally.

The sensor storage 41, the used sensor receptacle 42 and the assay stage 15 are arranged in the moving direction of the horizontal transfer shifter 48. The carriage 48a is shifted in the horizontal transfer shifter 48 which sets the suction device 46 in a selected one of a delivery position, standby position and discarding position. The delivery position is associated with the sensor storage 41 as indicated by the solid line. The standby position is associated with the assay stage 15 as indicated by the phantom line. The discarding position is associated with the used sensor receptacle 42 as indicated by the broken line.

The suction device 46 picks up the sensor unit 12 in the delivery position. At first, the vertical shifter 47 moves down the suction device 46 toward the sensor storage 41. The suction nozzles 46b are entered to the sensor storage 41, to capture an uppermost one of the sensor unit 12 by suction of its upper surface. After this, the suction device 46 is moved up by the vertical shifter 47 together with the sensor unit 12 in suction. After the pickup, the carriage 48a is moved to shift the suction device 46 to the standby position.

Transport rolls 51 as sensor transport mechanism are disposed on an entrance side of the assay stage 15. The standby position is defined where the sensor unit 12 picked up by the suction device 46 is transferred to the transport rolls 51. When the suction device 46 comes to the standby position, an end of the sensor unit 12 comes in contact with the transport rolls 51. Then the transport rolls 51 start rotation. Shortly before the start of the rotation, the suction device 46 releases the sensor unit 12. The sensor unit 12 is drawn forcibly by the transport rolls 51, and transferred from the suction device 46 to the transport rolls 51. Note that a standby panel 55 as standby position receives the sensor unit 12 released from the suction device 46, and prevents same from dropping.

The transport rolls 51 receive the sensor unit 12 from the suction device 46. Transport rolls 52 as sensor transport mechanism are adjacent to the transport rolls 51, and receive the sensor unit 12. Note that the standby position is also a position where the sensor unit 12 after the assay is transferred from the transport rolls 51 to the suction device 46.

The suction device 46, upon receiving the sensor unit 12 being used, moves to the discarding position. The suction device 46 moves down to enter the sensor unit 12 in the used sensor receptacle 42, and releases the sensor unit 12. Thus, the sensor unit 12 is left to drop in the used sensor receptacle 42.

The transport rolls 51 and 52 are roller couples, which squeeze and transport the sensor unit 12. Roll motors 53 and 54 transport the transport rolls 51 and 52 in forward and backward directions. The transport rolls 52 cause the sensor unit 12 from the transport rolls 51 to move so that the sensor chip 18 comes to a position between the flow channel block 20 and the prism 14. In the assay position, the sensing surface 13a is set at the flow channel 16, and the metal/dielectric interface or light entrance surface 13b for incidence of light is set on the prism 14. The transport rolls 52 keep the rear end of the sensor unit 12 stationary until the end of the assay after the reach of the sensor unit 12 at the assay position. This is the state of the position during the assay.

When the assay is completed, then the transport rolls 52 are caused to rotate backwards, to transfer the sensor unit 12 to the transport rolls 51. The transport rolls 51, upon receipt of the sensor unit 12 from the transport rolls 52, transport the sensor unit 12 to a downside of the suction device 46 which is in the standby position. Before the suction device 46 comes to retain the sensor unit 12 by suction, the transport rolls 52 retain one end of the sensor unit 12. Note that the number of pairs of the transport rolls 51, 52 may not be two, but can be one, or three or more. The number of the roller couples can be determined suitably according to a distance of the transport.

The sensor unit 12 in the assay position is firmly kept stationary between the flow channel block 20 and the prism 14. The flow channel block 20 is shiftable between a pressure position and a free position, and when in the pressure position, contacts the sensor unit 12 with pressure as indicated by the solid line, and when in the free position, becomes loose upwards from the pressure position as indicated by the phantom line. Also, the prism 14 is shiftable between a pressure position and a free position, and when in the pressure position, contacts a lower surface of the sensor unit 12 with pressure, and when in the free position, becomes loose downwards from the pressure position. A flow cell moving mechanism 56 moves the flow channel block 20. A prism moving mechanism 57 moves the prism 14. Each of the moving mechanisms 56 and 57 includes a motor. When the flow channel block 20 and the prism 14 come to the free position, a larger space is created between the flow channel block 20 and the prism 14 to render the sensor unit 12 movable with looseness.

The conduit 23 is flexible, and can be deformed according to moving up and down of the flow channel block 20. Plural tanks or reservoirs (not shown) are connected with the pump 59 for storing liquids, for example, analyte fluid, ligand fluid, buffer liquid and the like. A selection valve is operable for changing over the paths from the tanks to the pump 59. Thus, the liquids are selectively caused to flow through the conduit 23. Note that a pipette or the like may be used in place of the pump 59 for the purpose of flow of the liquid to the sensor unit 12.

A controller 61 controls various elements of the assay apparatus 11 sequentially, the elements including the transfer assembly 44, the transport rolls 51 and 52 and the moving mechanisms 56 and 57. This is a basis of automating the whole operation including pickup of the sensor unit 12, advance to the assay stage 15, assay and discarding of the sensor unit 12 after the assay.

The operation of the embodiment is described now. At first, an operator sets a plurality of the sensor units 12 being unused into the sensor storage 41. Upon instructions for starting the assay, the transfer assembly 44 is actuated for the suction device 46 to pick up an uppermost one of the sensor units 12 in the sensor storage 41, so the transfer assembly 44 moves the uppermost one to the standby position. The sensor unit 12 is displaced from the suction device 46 to the transport rolls 51 when in the standby position. The sensor unit 12 is transferred to the transport rolls 52, and enters the assay stage 15. When the sensor unit 12 reaches the assay position, the transport rolls 52 stop being driven. Then the moving mechanisms 56 and 57 are actuated to move the flow channel block 20 and the prism 14 to their pressure position. The sensor unit 12 is squeezed during the immobilizing and assay processes.

After the assay, the transport rolls 52 and 51 are rotated in the backward direction, to move back the sensor unit 12 to the standby position. The sensor unit 12 is transferred back to the suction device 46. The suction device 46 moves to the discarding position, and then moves down toward the used sensor receptacle 42. The sensor unit 12 is entered in the used sensor receptacle 42 and dropped. Thus, the sensor unit 12 being used is discarded in the used sensor receptacle 42. If a further assay is desired after the discarding, the suction device 46 is moved again to the delivery position, and the operation is repeated in a similar manner. Consequently, complexity in the loading and removal by manual handling can be reduced owing to the automation of the loading and removal of the sensor unit 12 on the assay stage 15.

Various modifications are possible for mechanisms to handle the sensor units. For example, a robot arm can be used in place of the transfer belt, and can have a suction device for pickup on its arm end. Also, a pickup chuck or claw mechanism may be used for grasp the sensor units on two ends in place of using the suction device for pickup.

Despite the single line of the sensor storage 41, the used sensor receptacle 42 and the assay stage 15 arranged according to the above embodiment, any modifications are possible for this arrangement. The pickup pads or suction device should be constructed to access any one of those three positions. Also, it is possible to use a robot arm, which can access to those three. The sensor storage 41, the used sensor receptacle 42 and the assay stage 15 may be disposed in any desired arrangement if the robot arm is used. Furthermore, the transfer assembly 44 for the transfer may be constituted two transfer mechanisms between the three stages. The used sensor receptacle 42 may be disposed in a position opposite to the standby position. After the assay, the sensor unit 12 can be moved to the opposite position.

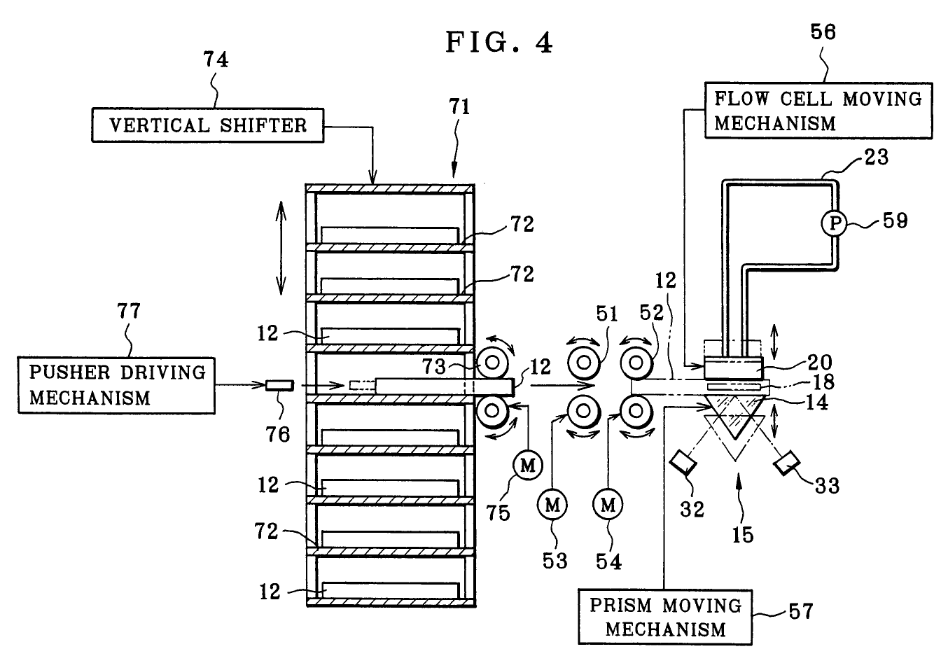

In the above embodiment, the used sensor receptacle 42 is separate from the sensor storage 41. In FIG. 4, another preferred embodiment is illustrated, in which a sensor rack 71 is used to contain not only unused ones of the sensor units 12 but used ones of the sensor units 12. There are tray portions 72 for supporting the sensor units 12 in a sorted manner.

The sensor rack 71 is a vertically extending rack and has the tray portions 72 lying over one another. The sensor unit 12 which may or may not be used is contained in one of the tray portions 72. Transfer rolls 73 as transfer shifter are disposed in the vicinity of the sensor rack 71, and move an unused one of the sensor units 12 from the tray portions 72 to the transport rolls 51, and also receive a used one of the sensor units 12 from the transport rolls 51. A roll motor 75 causes the transfer rolls 73 to rotate. The sensor rack 71 is movable up and down. A vertical shifter 74 moves the sensor rack 71 in the vertical direction. The entirety of the sensor rack 71 is moved up or down by the vertical shifter 74 so as to position each one of the tray portions 72 at the level of the transfer rolls 73.

A transfer pusher 76 as transfer shifter is dispose on a side opposite to the transfer rolls 73 relative to the sensor rack 71, and squeezes the sensor unit 12 of the chip type, and moves the same from the tray portions 72 toward the transfer rolls 73. A pusher driving mechanism 77 drives the transfer pusher 76. The transfer pusher 76 is movable between an inner position and an outer position, and when in the inner position, enters the sensor rack 71 to push out the sensor unit 12, and when in the outer position, comes away from the sensor rack 71 to keep the sensor rack 71 movable up and down. A handling assembly or transfer assembly is constituted by the transfer rolls 73 and the transfer pusher 76. An unused one of the sensor units 12 is taken up by the transfer assembly from the sensor rack 71, and transported to the assay stage 15 after coming to the transport rolls 51. At the same time, an unused one of the sensor units 12 is moved back to the sensor rack 71 in an empty one of the tray portions 72.

Other modifications of the used sensor receptacle 42 are possible. A structure disclosed in U.S. Pat. No. 5,674,454 (corresponding to JP-A 9-325151 and EP-B 0802413) can be used for stacking the sensor units 12 by reading the sample holders in the document as the sensor units 12. Also, a structure disclosed in U.S. Pat. No. 5,674,047 (corresponding to JP-A 9-033541) can be used for stacking by reading the probe tip trays in the document as the sensor units 12.

In addition to the SPR sensor, an assay sensor according to the invention can be other sensor in utilizing attenuated total reflection. One example of sensor according to utilizing the attenuated total reflection is a leaky mode sensor. The leaky mode sensor includes a dielectric medium, a cladding layer overlaid on the dielectric medium, and an optical waveguide layer overlaid on the cladding layer, those layers constituting a thin film. A first surface of the thin film is a sensing surface on the optical waveguide layer. A second surface of the thin film is a thin film/dielectric interface on the cladding layer. When light enters the thin film/dielectric interface to satisfy the condition of the total reflection, part of the light passes through the cladding layer, and enters the optical waveguide layer. A guided mode to propagate light is excited responsively in the optical waveguide layer, to attenuate the reflected light on the thin film/dielectric interface. An angle of the incidence at which the guided mode is excited is changeable according to the refraction index of the medium positioned on the sensing surface. This is similar to the characteristic of the resonance angle of the SPR sensor. The attenuation of the reflected light is detected, so that it possible to measure the interaction on the sensing surface.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An assay apparatus for assay in utilizing attenuated total reflection, including an assay stage for being loaded with at least one sensor unit of a chip type removably, said sensor unit having a transparent dielectric medium of a panel shape, and thin film with a first surface and a sensing surface reverse to said first surface, said first surface being fitted on said dielectric medium and constituted by a thin film/dielectric interface, and said sensing surface being adapted to causing interaction between ligand and analyte, and including a flow channel block, disposed in said assay stage, and having a flow channel for flowing of said analyte to said sensing surface, and an optical assay unit for applying illuminating light through said dielectric medium to said thin film/dielectric interface in such a form as to satisfy a condition of total reflection, and for detecting said illuminating light reflected by said thin film/dielectric interface during said interaction of said ligand and said analyte, said assay apparatus comprising:
a sensor storage for storing said sensor unit of said chip type in an unused state;
a used sensor receptacle for receiving said sensor unit in a used state after advance to said assay stage and use in said assay; and
a transfer assembly for retrieving said sensor unit for said assay from said sensor storage, for setting said sensor unit in said assay stage, and for discharging said sensor unit toward said used sensor receptacle.

2. An assay apparatus as defined in claim 1, wherein said optical assay unit includes a prism for firmly contacting said dielectric medium in said sensor unit, and for passing said illuminating light to said thin film/dielectric interface;
further comprising a shiftable mechanism for keeping said flow channel block and said prism movable between a pressure position and a free position, wherein said flow channel block and said prism, when in said pressure position, squeeze said sensor unit between, and when in said free position, have looseness relative to said sensor unit and set free said sensor unit.

3. An assay apparatus as defined in claim 1, wherein said transfer assembly includes:
a pickup mechanism for picking up said sensor unit from said sensor storage;
a transfer shifter for shifting said sensor unit being picked up to a standby position; and
a sensor transport mechanism for shifting said sensor unit from said standby position to said assay stage.

4. An assay apparatus as defined in claim 3, wherein said transfer assembly further includes a controller for, after said assay in said assay stage, causing said sensor shifter mechanism for shifting said sensor unit from said assay stage to said standby position, for causing said transfer shifter to shift said sensor unit from said standby position to an upside of said used sensor receptacle, and for causing said pickup mechanism to discharge said sensor unit to said used sensor receptacle.

5. An assay apparatus as defined in claim 3, wherein said pickup mechanism includes:
a pickup pad for capturing said sensor unit in said sensor storage;
a substantially vertical shifter for supporting said pickup pad to move said pickup pad a substantially vertical direction.

6. An assay apparatus as defined in claim 5, wherein said pickup pad is constituted by a suction device for retaining said sensor unit by suction.

7. An assay apparatus as defined in claim 3, wherein said transfer shifter includes a transfer belt, and a carriage, secured to said transfer belt, for moving when said transfer belt turns about;
wherein said pickup mechanism is secured to said carriage.

8. An assay apparatus as defined in claim 7, wherein said used sensor receptacle is disposed between said sensor storage and said standby position;
said transfer belt turns about in a forward direction before said assay, for moving said sensor unit from said used sensor receptacle to said standby position, and turns about in a backward direction after said assay, for moving said sensor unit from said standby position towards said used sensor receptacle.

9. An assay apparatus as defined in claim 3, wherein said sensor transport mechanism includes plural transport rolls rotatable back and forth, engaged with said sensor unit, for moving said sensor unit between said standby position and said assay stage.

10. An assay apparatus as defined in claim 2, comprising a sensor rack, having a plurality of tray portions, laid over one another therein, for constituting said sensor storage and said used sensor receptacle, and for respectively containing said sensor unit.

11. An assay apparatus as defined in claim 10, wherein said transfer assembly includes:
a transfer shifter for moving said sensor unit toward and away from said tray portions; and
a substantially vertical shifter for moving one of said sensor rack and said transfer shifter substantially in a vertical direction relative to a remaining one thereof, to set one of said tray portions at said transfer shifter where said sensor unit to be moved toward or away from said sensor rack is disposed.

12. An assay apparatus as defined in claim 11, wherein said sensor rack includes:
a rack casing, having a prismatic tubular shape, and disposed to extend substantially in said vertical direction; and
at least one lateral opening, formed in a lateral face of said rack casing, for allowing said transfer shifter to access said tray portions, to keep said sensor holder movable in and out.

13. An assay apparatus as defined in claim 11, wherein said vertical shifter moves said sensor rack.
